(19) United States
(12) Patent Application Publication
(10) Pub. No.: US 2020/0202828 A1
(43) Pub. Date: Jun. 25, 2020

(54) EFFECTS LOOP SEQUENCER FOR ROUTING MUSICAL INSTRUMENT OUTPUT

(71) Applicant: Ariel SCHERBACOVSKY, Atlanta, GA (US)

(72) Inventor: Ariel SCHERBACOVSKY, Atlanta, GA (US)

(21) Appl. No.: 16/718,508

(22) Filed: Dec. 18, 2019

Related U.S. Application Data
(60) Provisional application No. 62/781,686, filed on Dec. 19, 2018.

(51) Int. Cl. G10H 1/34; G10H 1/00

(52) U.S. Cl. CPC G10H 1/348; G10H 1/0066

(57) ABSTRACT

A loop sequencer is described that routes output signal received from a musical instrument to loops that impose audio or sound effects on an output signal received from a musical instrument. The loop sequencer includes an instrument audio input portal that receives the output signal from the instrument, and a loop switcher that automatically switches loops by ceasing the routing of the received output signal to the first loop and routing the received audio signal to the second loop, the automatic switching of the loops performed in response to a time signal, and then may continue to cycle through the loops to provide automatically sequential audio effects. The loop sequencer may be activated and/or deactivated for the automatic switching in response to the foot switch.

### CROSS-REFERENCE TO RELATED APPLICATION

The present non-provisional patent application claims the benefit of priority from U.S. Provisional Patent Application No. 62/781,686, filed Dec. 19, 2018, the entire contents of which are incorporated herein by reference.

### FIELD OF THE INVENTION

The present invention is in the field of audio signal processing for musical instruments and, in particular, relates to audio effects loop sequencing imposed on the audio output of a musical instrument, such as a guitar or synthesizer.

### BACKGROUND OF THE DISCLOSURE

Guitar effects pedals are in wide use to produce audio signal processing or sound effects known to musicians imposed on output signals received from a musical instrument. A musician, for example, a guitarist, can activate an effects for the instrument by pressing on an effects pedal, for example, by pressing on a foot switch of a pedal, such as a fuzz pedal, an overdrive pedal, or a reverb pedal, to modify the signal output to the listener. Such effects pedals can be arranged in loops so that the effects are sequentially imposed on the audio signal produced by the instrument.

Known in the prior art are various types of guitar pedals and associated equipment, for example U.S. Design Patent Publication Nos. 2018/0151162, Effects pedal board with integrated multi effects switcher, 2018/0053494, Digitally Pitch-Shifted Pedal Steel Guitar, 2017/0301326, Kit For Attaching Interchangeable Accessories To An Instrument, 2017/0140744, Guitar Pedal Board, 2016/0351175 Clawjammer finger pick, 2016/0019871, Transformable stand with an improved foot operated pitch changing mechanism for stringed instruments, 2015/0090096, Pedal Operated Configurable Guitar Chord Player, 2015/0013526 Portable Recording, Looping, and Playback System for Acoustic Instruments, 2014/0069264, Stringed Musical Instrument with an Auxiliary Pickup, 2013/0154920, Guitar Input and Output Dock for a Tablet Computer, 2013/0058507, Method for Transferring Data to a Musical Signal Processor, 2011/0259180 Guitar Pickup Assembly, 2011/0067549 Torsion oscillated spring corded contrabass guitar, 2010/0313739, Rhythm Recognition from an Audio Signal, 2010/0041477, Systems and Methods for Indicating Input Actions in a Rhythm-Action Game, 2008/0311969, Systems and Methods for Indicating Input Actions in a Rhythm-Action Game, 2006/0185494, Pitch changing arrangements for pedal steel guitar, 2006/0172584, Cable retention device, 2004/0261599 Tone control apparatus for guitars, 2004/0069127, Extensions and generalizations of the pedal steel guitar, 2002/0078821, Tug-a-wah. Each of the foregoing patent application publications is incorporated in full herein by reference.

Also well-known are loop switcher pedals that allow the musician to conveniently switch between such loops by pressing a button. For example, attached is a description of the one control white loop flash switcher pedal, which allows guitarists to press on the pedal to switch between a first loop, which may include one or more effects pedals, and a second loop, which may include one or more different effects pedals.

An A/B switch is also known in the field and is used to route instrument audio to either a first output or to a second output or to both outputs. The musician can thus route the instrument output into one of two amplifiers, or can switch between two guitar outputs going into one amp. A two loop switch routes the instrument output to effects loop A or effects loop B or both. Further, pedals are known that flash output between a first loop A and a second loop B in response to activation by a foot switch.

The boss ES-8 is a routing system that routes the guitar signal to one or more of eight effects loops in different orders and with various functionalities as set by the user. It may be controlled via a MIDI imprint (Musical Instrument Digital Interface) communications protocol input system. In this way, musicians can control the pedal board and tailor the switching as they wish.

### SUMMARY OF THE DISCLOSURE

Described is a manner of controlling audio or sound effects imposed or provided in conjunction with the audio output of a musical instrument, and a device, a system, a method, and means for implementing such a method, to attain a sequencing of such audio effects. According to an aspect of the disclosure, described is a loop sequencer that routes output signal received from a musical instrument to a plurality of loops comprising a first loop and a second loop, at least one of the loops including at least one effects device that imposes an audio effect on the output signal received from the musical instrument, the loop sequencer including an instrument audio input portal that receives the output signal from the musical instrument; and a loop switcher that automatically switches loops by ceasing the routing of the received output signal to the first loop and routing the received audio signal to the second loop, the automatic switching of the loops performed in response to a time signal.

Such a loop sequencer may further include at least one loop output receiver configured to receive, as an effects-enhanced audio signal, audio output generated by the plurality of effects loops; and an audio output portal configured to output the effects-enhanced audio signal.

In such a loop sequencer, the musical instrument may be a guitar.

The loop sequencer may include an effects pedal controlled by a foot switch, wherein the loop sequencer is configured to activate the automatic switching in response to the pressing of the foot switch by a user when the loop sequencer is not activated, and is configured to deactivate the automatic switching in response to the pressing of the foot switch by the user when the automatic switching is activated.

The first loop may include at least two effects devices, the two effects devices producing effects different from each other.

The loop sequencer may include a clock configured to generate the time signal.

The loop routing sequencer may include the loop switcher that switches sequentially to each of the first loop and the second loop for an equal amount of time.

The loop routing sequencer may include the loop switcher that switches to the first loop for a longer period than to the second loop.

The loop routing sequencer may include the loop switcher automatically to switch loops by ceasing the routing of the received output signal to the second loop, and routing the received output signal to a third loop of the plurality of the loops, the automatic switching performed in response to the time signal.

The loop routing sequencer may include the loop switcher automatically and repeatedly to cycle sequentially through the first and second loops by automatically ceasing the routing of the received output signal to the second loop and routing the received output signal to the first loop, the automatic switching performed in response to the time signal.

The loop routing sequencer may include at least one of the loops is a dry loop that imposes no significant audio effect on the received output signal.

In such a loop routing sequencer at least one of the loops may be an external audio unit configured to impose external audio on the received output signal, for example the external audio may be audio from a second musical instrument, synthesizer, white noise machine or drum machine.

The loop routing sequencer may include such an external audio unit that includes a recording medium and is configured to impose external audio from the recording medium on the received output signal.

The loop routing sequencer may include such an external audio unit to provide external audio from an external network and to impose the external audio on the received output signal.

Such a loop routing sequencer may include the loop switcher to automatically switch routing of the received output signal to a third loop of the plurality of the effects loops; and to automatically repeatedly cycle sequentially through the first, second and third loops; for example, the loop switcher may cause automatic skipping of the third loop every predetermined number of cycles through the first, second and third loops.

Such a loop routing sequencer may include the loop switcher that automatically switches routing of the received output signal to a third loop of the plurality of the effects loops, and to automatically repeatedly cycle sequentially through the first, second and third loops.

Such a loop routing sequencer may include the loop switcher that automatically switches routing of the received output signal from the second loop to a third loop of the plurality of the effects loops, and to allot more time to the third loop than to the first loop and the second loop.

Such a loop routing sequencer may include at least one loop output receiver that receives, as an effects-enhanced audio signal, audio output generated by the plurality of effects loops; an audio output portal configured to output the effects-enhanced audio signal; and a loop volume controller configured to output the effects-enhanced audio signal received from the first loop at a higher volume than the effects-enhanced audio signal received from the second loop.

Such a loop routing sequencer may include at least one of the audio input portal and the audio output portal is a USB port.

Also described is a loop sequencer that routes output signal received from a musical instrument to a plurality of loops comprising a first loop and a second loop, at least one of the loops including at least one external sound source unit that imposes an external sound on the output signal received from the musical instrument. Such a loop sequencer may include: an instrument audio input portal that receives the output signal from the musical instrument; and a loop switcher that automatically and repeatedly cycles sequentially through the first and second loops by automatically switching loops, the automatic switching performed in response to a time signal.

### BRIEF DESCRIPTION OF THE DRAWINGS

FIG. 1 is a flow diagram illustration of an effects loop sequence controller process with four loops, according to an aspect of the present disclosure.

FIG. 2 is a flow diagram illustration of the effects loop sequence controller with eight effects loops, according to an aspect of the present disclosure.

FIG. 3 illustrates an example of a loop sequencer device controlling sequencing through two loops, according to an aspect of the present disclosure.

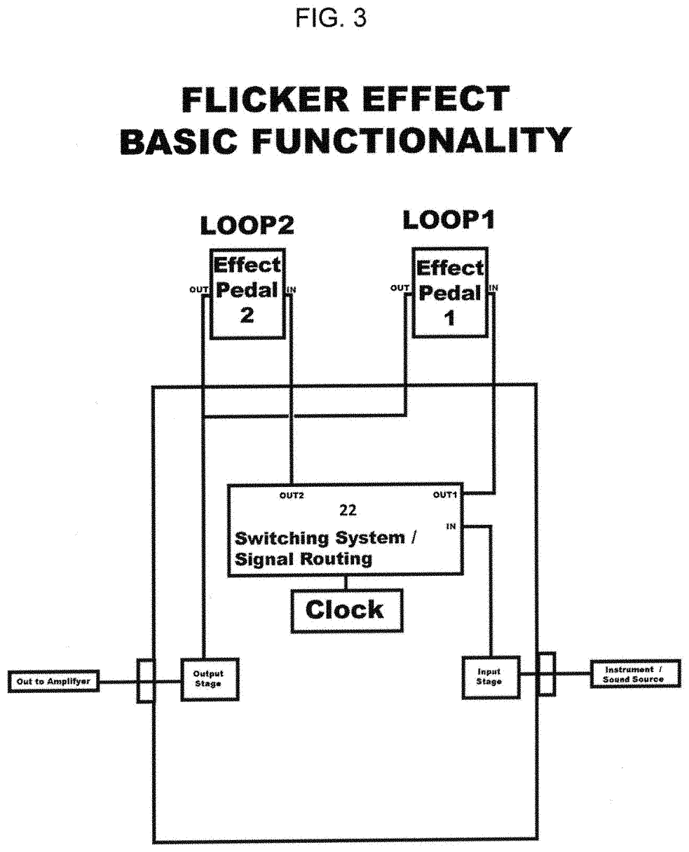

FIG. 4 is an illustration of an example of a loop sequencer device, including the sequencer and the switching system/signal router, controlling four loops, according to an aspect of the present disclosure.

FIG. 5 is an illustration of an example of a wiring diagram, according to an aspect of the present disclosure.

FIG. 6 is an illustration of a loop sequencer device similar to the one illustrated in FIG. 4, but illustrating an output of each loop being fed back to the switching system/signal router, according to an aspect of the present disclosure.

FIG. 7 is an illustration of a loop sequencer device similar to the one illustrated in FIG. 4, but illustrating loops that are “dry loops,” and also illustrating loops with additional instruments or external sources for sounds or recordings or the like, according to an aspect of the present disclosure.

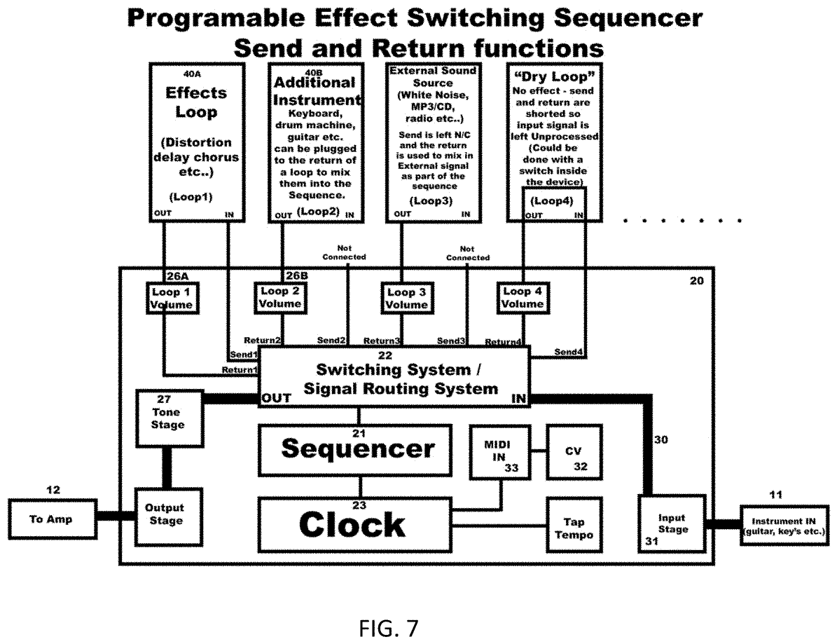

FIG. 8 is an illustration of a loop sequencer device similar to the one illustrated in FIG. 4, but illustrating that an output of the switching system is fed to a recording device, such as to a digital or analog recording device or system, for example, in a recording studio application, according to an aspect of the present disclosure.

The figures of the Drawings illustrate examples of aspects of the invention. Other features and advantages of the present invention will become apparent from the following description of the invention, and/or from the combination of one or more of the figures and the textual description herein, or from portions thereof.

### DETAILED DESCRIPTION OF THE EMBODIMENTS

Disclosed is an effects loop sequencer, an effects loop sequencing method, means for effects loop sequencing according to the method, and effects sequencing system that automatically switches between two or more effects loops according to a clock so as to create an effects loop sequence. In this way, the instrument output is automatically routed to effects loops according to the timing of the clock in real time, and the timing of the switching can be set by the musician according to the tempo desired for the music, for example, according to the length of the measure of the song. For example, each loop may be desired for a measure or routing through all of the loops may be desired in the course of one measure of the song. The sequence of loops may then be automatically repeated until the effects loop sequencer is deactivated, for example, by the guitarist stepping on a foot switch of a pedal or deactivating the loop sequencer by entering a command in some other manner. In this way, a resulting sound may be obtained by the sequenced signal routing to different effect loops in a particular set pattern, with switching between effects loops performed automatically in real time by the effects loop sequencer. The speed of the switching between loops may be set in advance by the user.

The musical instrument and/or one or more of the loops may be connected by wired or wireless connection to the effects loop sequencer. The length of time allotted to any effects loop before the effects loop sequencer switches automatically to the next loop may be set by a user and may be varied by user controls on or associated with the effects sequencer. Similarly, the volume for each effects loop and the duty cycle may be set by the user according to musical tastes and preferences for song arrangement.

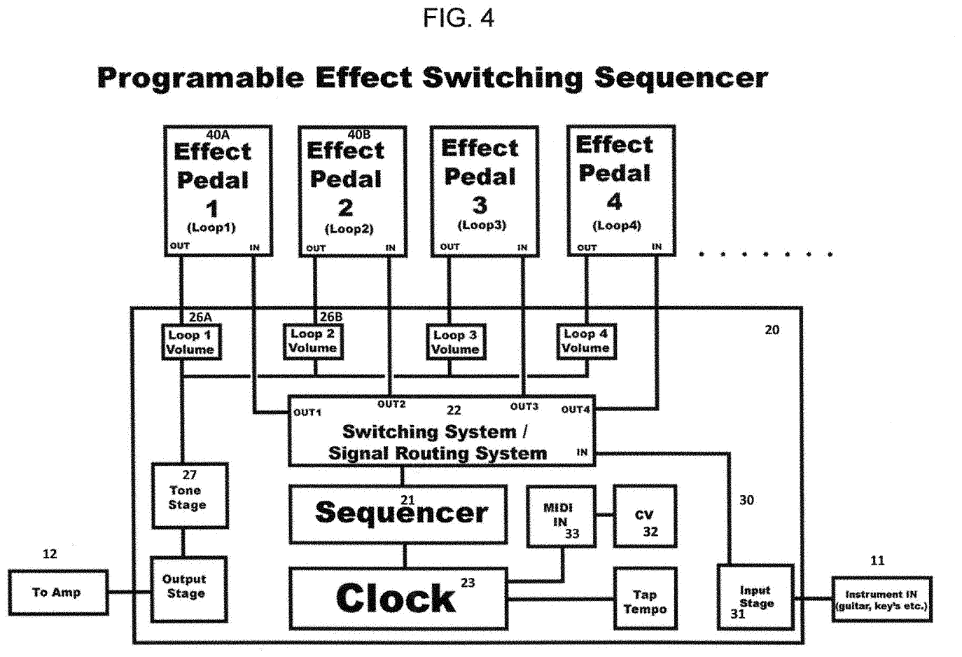

FIG. 4 illustrates an example of a loop sequencer 20 according to an aspect of the present disclosure. Loop sequencer 20 may be implemented as a pedal, such that activation of the pedal by a guitarist's foot starts the sequencing of instrument output through the effects loops. It will be understood, however that an amplifier 12 may be integrated as part of loop sequencer 20, and that loop sequencer 20 may be integrated as part of a larger sound effects or control system, such as a synthesizer box or may be provided as part of a musical instrument.

With further reference to FIG. 4, an instrument, such as a guitar, or other string instrument, such as a guitar, bass guitar, or other type of instrument, such as a keyboard, provides an output to input unit 30 of loop sequencer 20. Input unit 30 may include input stage 31, which may include an electronic buffer that controls tonality, a standard electric guitar output interface, a USB port or the like. Sequencer 21 may be controlled by clock 23 pursuant to input from MIDI input 33 and/or a gate such as a CV (control voltage) 32 if an analog method of control is used. Tap tempo 34 may also provide input to the clock 23. MIDI may be used to control the clock that controls the timing of the route switching between loops, may synchronize the clock with other instruments, determine which effects loop is to be turned on and for how long, which effects loop is to be skipped every given number of cycles through the loops, may be used to control volume, and may provide other such control and setting signals. A DAW (digital audio workstation) or other MIDI device may provide such functionality, and may be connected to the clock, the effects loop switcher, and/or to the loop sequencer as a whole.

Sequencer 21, according to the clock output 23, controls signal switching 22 to route the output signal received from instrument 11 by input stage 31 to one of the loops via output 1, output 2, output 3, output 4 of signal switcher 22. While FIG. 4 illustrates four effects pedal loops (loop 1, loop 2, loop 3, loop 4), it would be understood that two or more effects loops may be provided, for example, eight or six or twelve or more. One or more of the loops may comprise a “dry loop” that imposes no audio effects, and/or one or more of the loops may comprise another musical instrument and/or other sound producing equipment or circuits, such as a white noise machine, MP3 recording, world wide web or other network streaming, or other external sound source. Also, while FIG. 4 illustrates one effects pedal for each loop, it will be understood that more than one effects pedal may be provided for any loop and the loops need not have the same number of effects pedals as the other loops. Also, the effects pedals or other structures or circuits or chips that impose audio effects on a musical instrument output may be built into or otherwise integrated with the switching system/signal routing system 22 and/or may be built into or otherwise integrated with sequencer 21. Similarly, other sound or music producing equipment, musical instrument, recording or other external sound source of the types discussed herein may be built into or otherwise integrated with the switching system/signal routing system 22 and/or may be built into or otherwise integrated with sequencer 21.

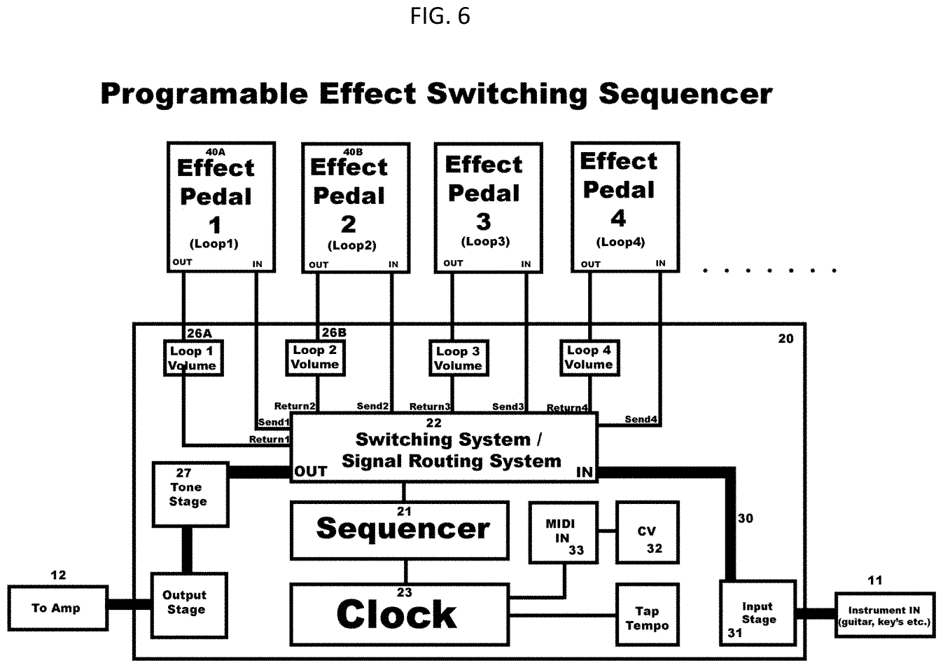

FIG. 4 also illustrates loop 1 volume 26A, which can control the volume that is provided by loop 1, and volume 26B, which controls the volume provided by loop 2. Based on the switching provided by signal switching 22, the output of loops 1, 2, 3, 4 are provided via output ports of the effects pedals to tone stage 27 and to output stage 28. This may then be output by loop sequencer 20 to an external device such as an amplifier 12. As illustrated in FIG. 6, the output of some or all of the effects loop may be led back to switching system/signal router, for example, after the output signal passes through volume control. In this way, impedance may be suppressed or controlled.

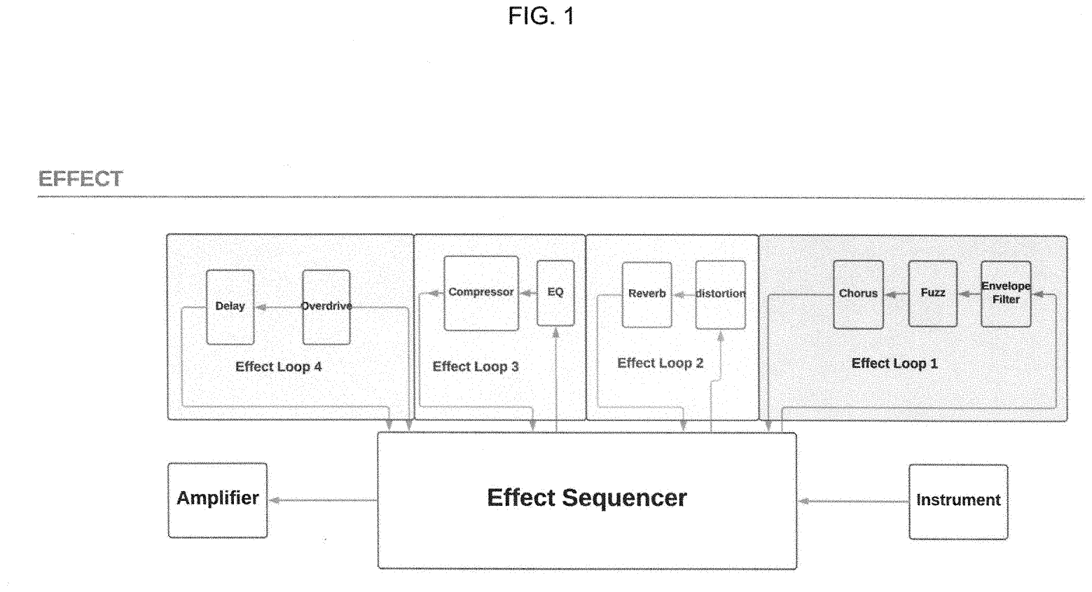

An example of a process flow will now be discussed with respect to FIG. 1. A musician sets up effects loop 1, comprising an envelope filter as a first effects pedal, a fuzz pedal as a second effects pedal, and a chorus pedal as a third effects pedal. Many types of audio signal processing units are contemplated as the effects pedals or other units that impose effects on an instrument output, such as fuzz, overdrive, reverb, echo, reverse echo, flanger, phaser, chorus, equalization, pitch shift, filtering, time stretching, resonators, overdrive, robotic voice effects, modulation, including amplitude or frequency modulation, wave field synthesis, compression, and variations and combinations of the foregoing.

Also, an effects loop may comprise signal received from an external audio source device, such as one or more of the following: another musical instrument, a synthesizer, an audio recording, such as a CD or MP3 player, a radio station, streaming audio from the Internet or another external network, such a LAN (local area network) or WAN (wide area network), signal received via WIFI, a white noise machine, drum machine, or the like, or a combination of the foregoing. Like the audio effects pedal, such an external audio source device may be connected as part of the loop via a wired or wireless connection to the loop sequencer, to other audio effects pedals, to other external audio source devices and/or to an external network, such as the Internet, a LAN or WAN. Such loops containing one or more external audio source devices may be switched to and from, and may be controlled in ways similar to other loops of the system. They may include volume controls, they may be switched to for time periods similar in length to, shorter than or greater than other loops of the system, they may be skipped every second or every few cycles, and the like. Also, their outputs may be fed back to the switching system/signal routing system as illustrated in FIG. 6, their outputs may be routed directly to an output stage or output portal, to an amplifier, or the like.

Further, a single loop may include one or more external audio source devices, or may in addition include one or more audio effects devices or pedals. Also contemplated is an installation in which a first loop includes one or more external audio source devices and a second loop includes one or more audio effects pedals. It will be understood that two or more such audio effects pedals may be integrated as part of the same physical pedal and that such pedals may be part of a larger musical effects device or musical instrument. Similarly, one or more external audio source devices may be physically integrated as part of the same device and/or may be physically integrated with one or more audio effects pedals.

Also, one or more loops in the cycle of loops that the loop sequencer switches through may be a “clean” or “dry” loop that imposes no audio signal processing or sound effects. For example, the loop sequencer may route the signal to a signal cable, and then back to the loop sequencer, or to an amp and then back to the loop sequencer. It will be understood that some minimal or unintended audio effects may be imposed by a “dry” loop, for example, as the signal passes into and/or out from a cable that forms the dry loop. In this way, the musician can obtain a clean or dry sound alternating with a “wet” or audio effects enhanced sound for the musical instrument.

The musician also routes instrument output to a second loop for purposes of illustrative example, comprising a first effects pedal that is a distortion pedal, and a reverb pedal as a second effects pedal of the second loop, and the musician wishes equalizer effects pedal as a first effects pedal of effect loop 3 and a compressor effects pedal as a second effects pedal of loop 3. Finally in this example, the musician may choose the overdrive effects pedal as the first effects pedal of loop 4 and delay effects pedal as a second effects loop pedal of effects loop 4. Also, for purposes of illustrative example only, FIG. 1 illustrates that each loop has a different set of effects pedals in each of the loops. Effects pedals may be repeated in more than one loop. For example, the musician may wish a tremolo effects as the last effects pedal of each loop or as the last effects pedal of every other loop, and so on. Also, while the effects pedals are illustrated as being sequential, it will be understood that the effects pedals of each loop may be audio overlaid on top of each other so that they are cumulatively imposed on every part of the signal passing through the effects loop. Additional effects not illustrated may also be provided.

The musician may wish to cycle through effects loop 1 for the same duration of effects loop 2, effects loop 3 and effects loop 4, or may wish to allot more time to effects loop 1 and effects loop 2 or vice versa. Effects sequencer or loop sequencer 20 may be set to effectuate such time allotments. In addition, effects sequencer or loop sequencer 20 may be set so that one or more of the effects loops is skipped every second cycle through the effects loops, or is skipped every third cycle, or the like. It will be understood that while FIG. 1 illustrates four effects loops fewer than four or more than four effects loops may be provided, and that each effects loop may comprise one or more effects pedals as desired by the musician.

The musician may wish to provide a uniform timing for all the effects loops so that according to each timing of the clock, for example, after one second, the effects sequencer routes the musical instrument output from effects loop 1 to effects loop 2, and then after a further second the effect sequencer routes the musical instrument output to effects loop 3, and then after a further second the effects sequencer routes the musical instrument output to effects loop 4, and after the last effects loop in the cycle, the effects sequencer routes the musical instrument output back to effects loop 1 where a new cycle begins. The speed at which the loops are switched can be set according to the preferences of the musician. According to the settings, effects sequencer or loop sequencer 20 then cycles through sequentially from effects loop 1, to effects loop 2, to effects loop 3, to effects loop 4, and then cycles back to loop 1, loop 2 and so on until the effect sequencer 20 is deactivated. This loop cycling is done such that effects sequencer or loop sequencer 20 automatically moves between loops, according to the clock. For example, a musician may wish to cycle through all four effects loops in the course of a single measure of the song or approximately in that time. The musician can thus set the speed of the switching controlling the effects loop sequencer 20 according to his or her preferences to control the musical effects imposed on the instrument output.

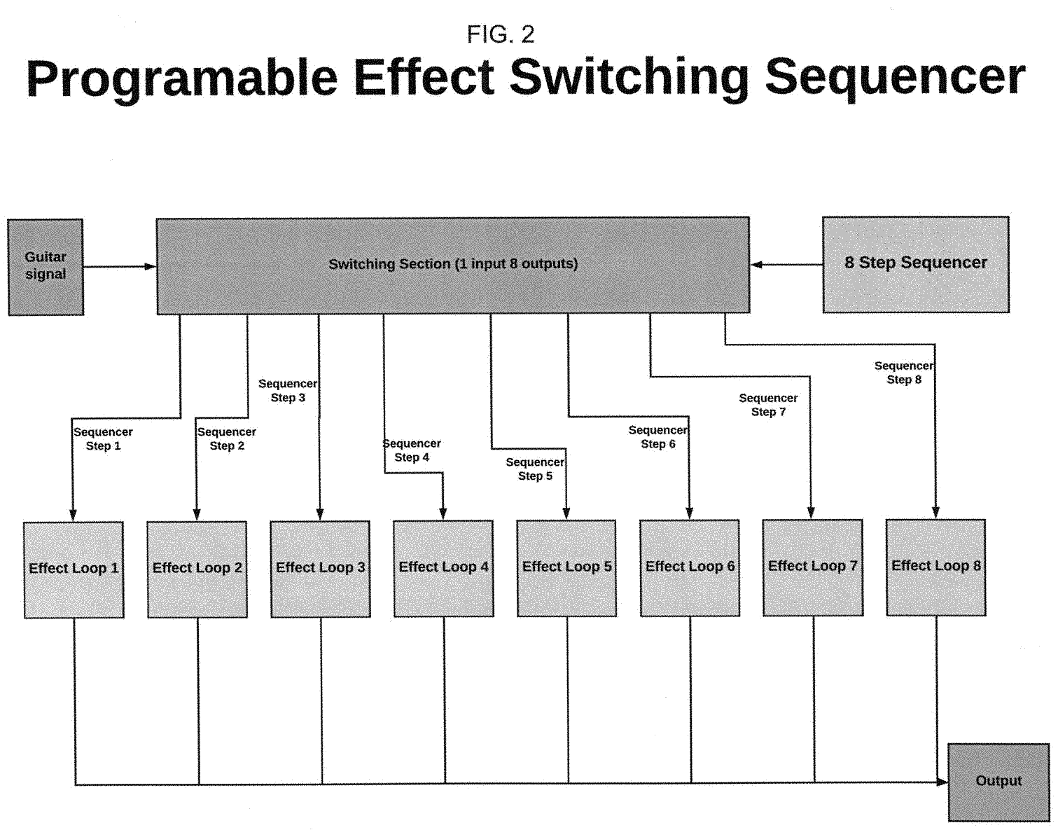

FIG. 2 is a process flow diagram illustrating eight effects loops being controlled by loop sequencer 20. For example, a guitarist may wish that a first one eighth of the measure be sequenced through effects loop 1, while the second one eighth be sequenced through effects loop 2 and so on. Thus, it may be the case that the greater the number of effects loops through which loop sequencer 20 switches the guitar output, the faster the switching or the smaller the section of music that is sequenced through each effects loop. However, the musician can set the switching by the loop sequencer 20 according to the speed that he or she desires. For example, the effects loop sequencer may be set to have an effects loop 1 for the first measure of song, effects loop 2 for the second measure, effects loop 3 for the third measure and effects loop 4 for the fourth measure, and then switch back to the effects loop 1 for the fifth measure and so on for a particular song.

In addition, loop sequencer 20 may be controlled via MIDI or USB, or MIDI or USB may be used to connect the loop sequencer 20 with other hardware or with additional software. Loop sequencer 20 may be connected to additional instruments, such as a synthesizer, or with additional software. A plugin version of such a loop sequencer 20 may also be provided so that keyboards or other instruments can thus be controlled, for example, using a digital audio workstation (DAW).

Two or more instruments, by way of example, a synthesizer and a guitar, or a lead guitar and a bass guitar, may be simultaneously connected, via a wired or wireless connection, to loop sequencer 20. In this way, the output of both instruments would be controlled in the same way by loop sequencer 20 to sequence through the four effects loops. However, it will be understood that components may be connected to each other using any type of wired or wireless connection, for example, using WIFI. Components illustrated or described herein as part of the same unit or device may be provided separately, and structures illustrated or described herein as different or remotely spaced from each other may be integrated.

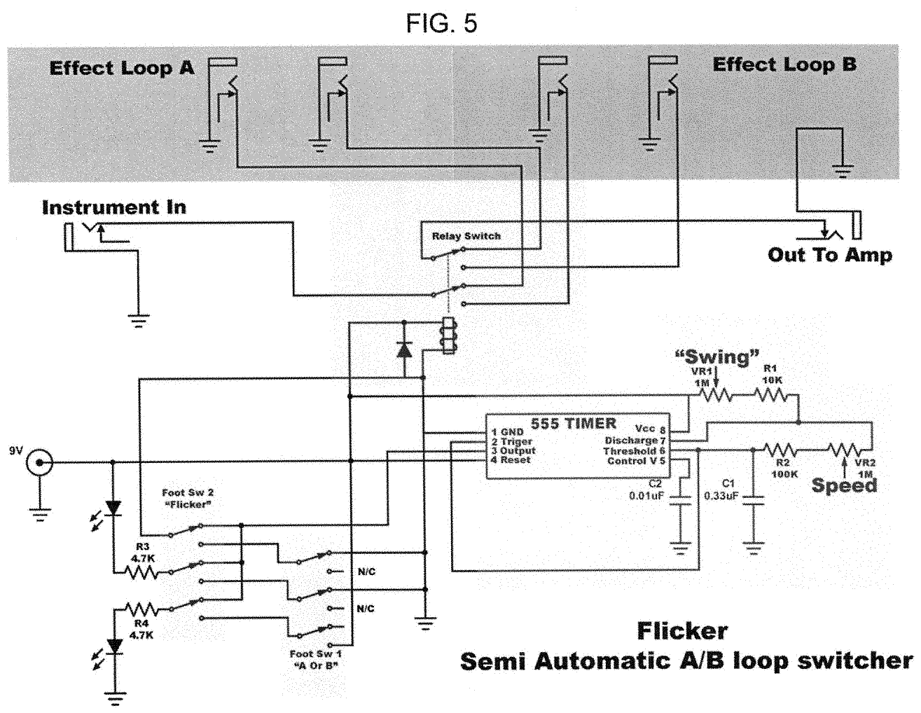

FIG. 5 is an illustration of a circuit diagram illustrating aspects of a two loop system being controlled by loop sequencer 20. It will be understood that many other such circuit diagrams may be used to implement system control by loop sequencer 20 and that additional components may be provided that are not illustrated in FIG. 5. Components described as being implemented by hardware may be implemented as software running on a computer or other data processor. Connections or links between components may be implemented as USB cables, HMDI cable, Firewire cords, analog signal cables, speaker wire, wireless connection, including WIFI or near field radio signal system or the like, or a combination of the foregoing.

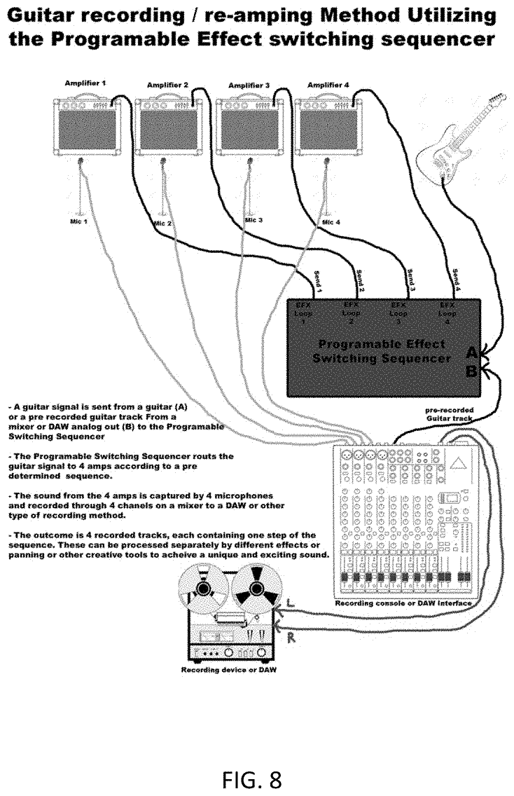

FIG. 8 is an illustration of a loop sequencer device illustrating that an output of the switching system is fed to a recording device, such as to a digital or analog recording device or system. For example, in a recording studio such a recording system may be set up. Also, the output of the system may be streamed over a network, such as a LAN or the Internet, for broadcasting or streaming over the network and/or for recording and later playback or the like.

In this way, a pedal or other device, a system, a method, a non-transient data processor-readable medium incorporating instructions configured to perform the method and/or to implement loop effects sequencing, and means for performing the method are described so that convenient and automated music effects sequencing and repeated cycling of musical effects may be provided. Further, the automated effects routing from effects loop to effects loop may be provided in a fast, precise and reliable way, and the speed of the switching between effects may be set by the user.

Although the present invention has been described in relation to particular embodiments thereof, many other variations, combinations of features and modifications and other uses will become apparent to those skilled in the art. Structures outlined as adjacent need not necessarily be positioned in that way, not all steps structures illustrated or described necessarily are provided, and other intervening structures may be inserted. It is preferred, therefore, that the present invention be limited not by the specific disclosure herein.
11 Instrument
12 Amplifier
20 Loop sequencer
21 Sequencer
22 Signal switching
23 Clock
25 Signal outputs
26A-D Loop volume controller
27 Tone stage
28 Output stage
30 Input unit
31 Input stage
32 Gate
33 MIDI in
34 Tap tempo
40A Loop 1
40B Loop 2
41A-1 Effects pedal 1
41A-2 Effects pedal 2
41A-3 Effects pedal 3
41B-1 Effects pedal 1
41B-2 Effects pedal 2

What is claimed is:

1. A loop sequencer configured to route output signal received from a musical instrument to a plurality of loops comprising a first loop and a second loop, at least one of the loops comprising at least one effects device that imposes an audio effect on the output signal received from the musical instrument, the loop sequencer comprising:
an instrument audio input portal configured to receive the output signal from the musical instrument; and
a loop switcher configured to automatically switch loops by ceasing the routing of the received output signal to the first loop and routing the received audio signal to the second loop, the automatic switching of the loops performed in response to a time signal.

2. The loop sequencer of claim 1, further comprising:
at least one loop output receiver configured to receive, as an effects-enhanced audio signal, audio output generated by the plurality of effects loops; and
an audio output portal configured to output the effects-enhanced audio signal.

3. The loop sequencer of claim 1, wherein the musical instrument is a guitar.

4. The loop sequencer of claim 1, wherein the loop sequencer comprises an effects pedal controlled by a foot switch,
wherein the loop sequencer is configured to activate the automatic switching in response to the pressing of the foot switch by a user when the loop sequencer is not activated, and is configured to deactivate the automatic switching in response to the pressing of the foot switch by the user when the automatic switching is activated.

5. The loop sequencer of claim 1, wherein the first loop comprises at least two effects devices, the two effects devices producing effects different from each other.

6. The loop sequencer of claim 1, further comprising a clock configured to generate the time signal.

7. The loop routing sequencer of claim 1, wherein the loop switcher is configured to switch sequentially to each of the first loop and the second loop for an equal amount of time.

8. The loop routing sequencer of claim 1, wherein the loop switcher is configured to switch to the first loop for a longer period than to the second loop.

9. The loop routing sequencer of claim 1, wherein the loop switcher is configured to automatically switch loops by ceasing the routing of the received output signal to the second loop, and routing the received output signal to a third loop of the plurality of the loops, the automatic switching performed in response to the time signal.

10. The loop routing sequencer of claim 1, wherein the loop switcher is configured to automatically repeatedly cycle sequentially through the first and second loops by automatically ceasing the routing of the received output signal to the second loop and routing the received output signal to the first loop, the automatic switching performed in response to the time signal.

11. The loop routing sequencer of claim 1, wherein at least one of the loops is a dry loop that imposes no significant audio effect on the received output signal.

12. The loop routing sequencer of claim 1, wherein at least one of the loops comprises an external audio unit configured to impose external audio on the received output signal, wherein the external audio is audio from a second musical instrument, synthesizer, white noise machine or drum machine.

13. The loop routing sequencer of claim 1, wherein the external audio unit comprises a recording medium and is configured to impose external audio from the recording medium on the received output signal.

14. The loop routing sequencer of claim 1, wherein the external audio unit is configured to provide external audio from an external network and to impose the external audio on the received output signal.

15. The loop routing sequencer of claim 1, wherein the loop switcher is configured:
to automatically switch routing of the received output signal to a third loop of the plurality of the effects loops; and
to automatically repeatedly cycle sequentially through the first, second and third loops;
wherein the loop switcher is further configured to automatically skip the third loop every predetermined number of cycles through the first, second and third loops.

16. The loop routing sequencer of claim 1, wherein the loop switcher is configured:
to automatically switch routing of the received output signal to a third loop of the plurality of the effects loops, and
to automatically repeatedly cycle sequentially through the first, second and third loops.

17. The loop routing sequencer of claim 1, wherein the loop switcher is configured:
to automatically switch routing of the received output signal from the second loop to a third loop of the plurality of the effects loops, and
to allot more time to the third loop than to the first loop and the second loop.

18. The loop routing sequencer of claim 1, further comprising:
at least one loop output receiver configured to receive, as an effects-enhanced audio signal, audio output generated by the plurality of effects loops;
an audio output portal configured to output the effects-enhanced audio signal; and
a loop volume controller configured to output the effects-enhanced audio signal received from the first loop at a higher volume than the effects-enhanced audio signal received from the second loop.

19. The loop routing sequencer of claim 1, wherein at least one of the audio input portal and the audio output portal is a USB port.

20. A loop sequencer configured to route output signal received from a musical instrument to a plurality of loops comprising a first loop and a second loop, at least one of the loops comprising at least one external sound source unit that imposes an external sound on the output signal received from the musical instrument, the loop sequencer comprising:
an instrument audio input portal configured to receive the output signal from the musical instrument; and
a loop switcher is configured to automatically repeatedly cycle sequentially through the first and second loops by automatically switching loops, the automatic switching performed in response to a time signal.
